(19) United States
(12) Patent Application Publication
(10) Pub. No.: US 2014/0029559 A1
(43) Pub. Date: Jan. 30, 2014

(54) METHOD FOR TERMINAL TO RECEIVE DOWNLINK SIGNAL FROM BASE STATION IN WIRELESS COMMUNICATION SYSTEM AND DEVICE THEREFOR

(71) Applicants: Hanbyul Seo, Anyang-si (KR); Hakseong Kim, Anyang-si (KR)

(72) Inventors: Hanbyul Seo, Anyang-si (KR); Hakseong Kim, Anyang-si (KR)

(73) Assignee: LG ELECTRONICS INC., Seoul (KR)

(21) Appl. No.: 14/110,663

(22) PCT Filed: Apr. 18, 2012
(86) PCT No.: PCT/KR2012/002923

§ 371 Date: Oct. 8, 2013

Related U.S. Application Data
(60) Provisional application No. 61/482,173, filed on May 3, 2011.

(51) Int. Cl. H04W 72/04

(52) U.S. Cl. CPC H04W 72/042
USPC 370/329

(57) ABSTRACT

Disclosed in the present invention is a method for a terminal to receive downlink data from a base station in a wireless communication system. More particularly, the present invention comprises the steps of: receiving downlink control information from the base station in a first subframe; confirming a specific identifier included in the downlink control information; and when the specific identifier is more than or equal to a predetermined value, receiving downlink data in a second subframe, on the basis of the downlink control information.

### TECHNICAL FIELD

The present invention relates to a wireless communication system, and more particularly, to a method of receiving a downlink signal, which is received by a user equipment from an eNode B in a wireless communication system and an apparatus therefor.

### BACKGROUND ART

3GPP LTE (3^{rd} generation partnership project long term evolution hereinafter abbreviated LTE) communication system is schematically explained as an example of a wireless communication system to which the present invention is applicable.

FIG. 1 is a schematic diagram of E-UMTS network structure as one example of a wireless communication system. E-UMTS (evolved universal mobile telecommunications system) is a system evolved from a conventional UMTS (universal mobile telecommunications system). Currently, basic standardization works for the E-UMTS are in progress by 3GPP. E-UMTS is called LTE system in general. Detailed contents for the technical specifications of UMTS and E-UMTS refers to release 7 and release 8 of “3^{rd} generation partnership project; technical specification group radio access network”, respectively.

Referring to FIG. 1, E-UMTS includes a user equipment (UE), an eNode B (eNB), and an access gateway (hereinafter abbreviated AG) connected to an external network in a manner of being situated at the end of a network (E-UTRAN). The eNode B may be able to simultaneously transmit multi data streams for a broadcast service, a multicast service and/or a unicast service.

One eNode B contains at least one cell. The cell provides a downlink transmission service or an uplink transmission service to a plurality of user equipments by being set to one of 1.25 MHz, 2.5 MHz, 5 MHz, 10 MHz, 15 MHz, and 20 MHz of bandwidths. Different cells can be configured to provide corresponding bandwidths, respectively. An eNode B controls data transmissions/receptions to/from a plurality of the user equipments. For a downlink (hereinafter abbreviated DL) data, the eNode B informs a corresponding user equipment of time/frequency region on which data is transmitted, coding, data size, HARQ (hybrid automatic repeat and request) related information and the like by transmitting DL scheduling information. And, for an uplink (hereinafter abbreviated UL) data, the eNode B informs a corresponding user equipment of time/frequency region usable by the corresponding user equipment, coding, data size, HARQ-related information and the like by transmitting UL scheduling information to the corresponding user equipment. Interfaces for user-traffic transmission or control traffic transmission may be used between eNode Bs. A core network (CN) consists of an AG (access gateway) and a network node for user registration of a user equipment and the like. The AG manages a mobility of the user equipment by a unit of TA (tracking area) consisting of a plurality of cells.

Wireless communication technologies have been developed up to LTE based on WCDMA. Yet, the ongoing demands and expectations of users and service providers are consistently increasing. Moreover, since different kinds of radio access technologies are continuously developed, a new technological evolution is required to have a future competitiveness. Cost reduction per bit, service availability increase, flexible frequency band use, simple structure/open interface and reasonable power consumption of user equipment and the like are required for the future competitiveness.

### DISCLOSURE OF THE INVENTION

### Technical Task

Accordingly, the present invention intends to propose a method of receiving a downlink signal, which is received by a user equipment from an eNode B in a wireless communication system and an apparatus therefor in the following description based on the discussion as mentioned in the foregoing description.

### Technical Solution

To achieve these and other advantages and in accordance with the purpose of the present invention, as embodied and broadly described, according to one embodiment, a method for receiving a downlink data from an eNode B at a user equipment in a wireless communication system includes the steps of receiving a downlink control information from the eNode B in a first subframe, confirming a specific identifier included in the downlink control information, and if the specific identifier is greater than or equal to the predetermined value, receiving the downlink data in a second subframe based on the downlink control information. And, if the specific identifier is less than the predetermined value, the method can further include receiving the downlink data in the first subframe based on the downlink control information.

Preferably, if the downlink data is received in the first subframe, the method can further include transmitting a response signal for the downlink data in a first uplink subframe linked to the downlink control information. If the downlink data is received in the second subframe, the method can further include transmitting the response signal for the downlink data in a second uplink subframe configured by an upper layer signal. In this case, the first uplink subframe and the second uplink subframe can be configured with a transmit power different from each other.

Meanwhile, to further achieve these and other advantages and in accordance with the purpose of the present invention, according to a different embodiment, a user equipment in a wireless communication system includes a radio communication module configured to transceive a signal with an eNode B and a processor configured to process the signal, the radio communication module configured to receive a downlink control information from the eNode B in a first subframe, the processor configured to confirm a specific identifier included in the downlink control information, if the specific identifier is greater or equal to the predetermined value, the processor configured to control the radio communication module to receive the downlink data in a second subframe based on the downlink control information. And, if the specific identifier is less than the predetermined value, the processor is configured to control the radio communication module to receive the downlink data in the first subframe based on the downlink control information.

Moreover, if the downlink data is received in the first subframe, the processor is configured to control the radio communication module to transmit a response signal for the downlink data in a first uplink subframe linked to the downlink control information and if the downlink data is received in the second subframe, the processor is configured to control the radio communication module to transmit the response signal for the downlink data in a second uplink subframe configured by an upper layer signal.

In this case, the second subframe corresponds to a downlink subframe or an uplink subframe defined by an upper layer signal after the first subframe.

More preferably, the specific identifier means a HARQ (hybrid automatic repeat and request) process identifier (number).

### Advantageous Effects

According to embodiments of the present invention, a user equipment can efficiently receive a downlink signal from an eNode B in a wireless communication system.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1 is a schematic diagram of E-UMTS network structure as one example of a wireless communication system;

FIG. 2 is a diagram for structures of control and user planes of radio interface protocol between a 3GPP radio access network standard-based user equipment and E-UTRAN;

FIG. 3 is a diagram for explaining physical channels used for 3GPP system and a general signal transmission method using the physical channels;

FIG. 4 is a diagram for a structure of a radio frame in LTE system;

FIG. 5 is a diagram for a structure of a downlink radio frame in LTE system;

FIG. 6 is a diagram for a structure of an uplink subframe in LTE system;

FIG. 7 is a flowchart of a method of receiving PDSCH according to a first embodiment of the present invention;

FIG. 8 is a flowchart of a method of receiving PDSCH according to a second embodiment of the present invention;

FIG. 9 is a block diagram of an example for a communication device according to one embodiment of the present invention.

### BEST MODE

### Mode for Invention

In the following description, compositions of the present invention, effects and other characteristics of the present invention can be easily understood by the embodiments of the present invention explained with reference to the accompanying drawings. Embodiments explained in the following description are examples of the technological features of the present invention applied to 3GPP system.

In this specification, the embodiments of the present invention are explained using an LTE system and an LTE-A system, which is exemplary only. The embodiments of the present invention are applicable to various communication systems corresponding to the above mentioned definition.

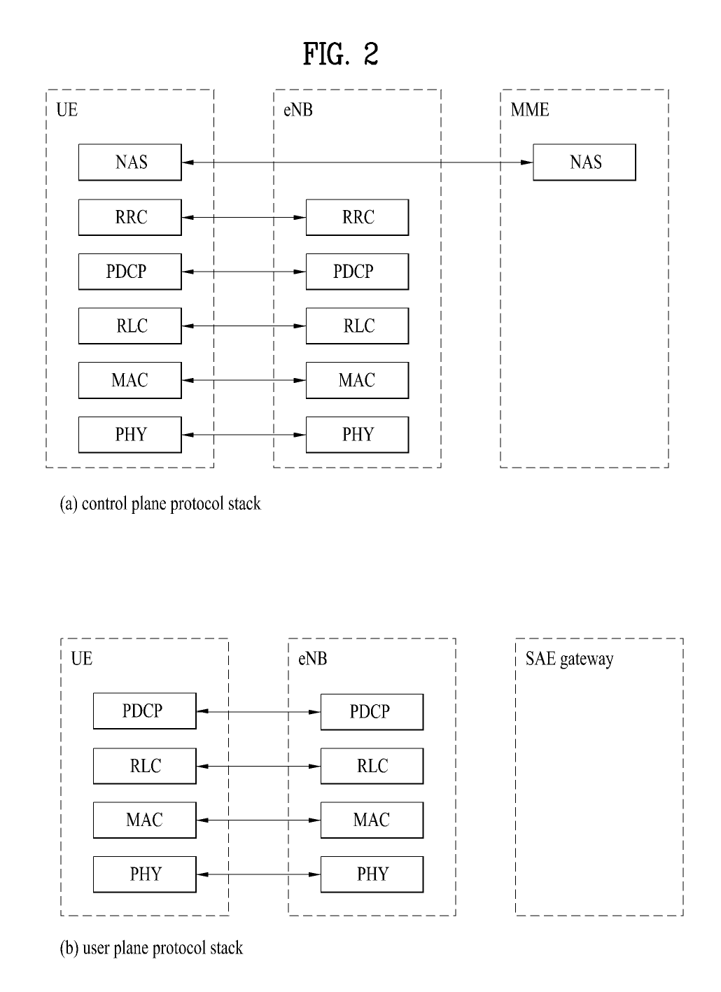

FIG. 2 is a diagram for structures of control and user planes of radio interface protocol between a 3GPP radio access network standard-based user equipment and E-UTRAN. The control plane means a path on which control messages used by a user equipment (UE) and a network to manage a call are transmitted. The user plane means a path on which such a data generated in an application layer as audio data, internet packet data, and the like are transmitted.

A physical layer, which is a 1^{st} layer, provides higher layers with an information transfer service using a physical channel. The physical layer is connected to a medium access control layer situated above via a transport channel. Data moves between the medium access control layer and the physical layer on the transport channel. Data moves between a physical layer of a transmitting side and a physical layer of a receiving side on the physical channel. The physical channel utilizes time and frequency as radio resources. Specifically, the physical layer is modulated by OFDMA (orthogonal frequency division multiple access) scheme in DL and the physical layer is modulated by SC-FDMA (single carrier frequency division multiple access) scheme in UL.

Medium access control (hereinafter abbreviated MAC) layer of a 2^{nd} layer provides a service to a radio link control (hereinafter abbreviated RLC) layer, which is a higher layer, on a logical channel. The RLC layer of the 2^{nd} layer supports a reliable data transmission. The function of the RLC layer may be implemented by a function block within the MAC. PDCP (packet data convergence protocol) layer of the 2^{nd} layer performs a header compression function to reduce unnecessary control information, thereby efficiently transmitting such IP packets as IPv4 packets and IPv6 packets in a narrow band of a radio interface.

Radio resource control (hereinafter abbreviated RRC) layer situated in the lowest location of a 3^{rd} layer is defined on a control plane only. The RRC layer is responsible for control of logical channels, transport channels and physical channels in association with a configuration, a re-configuration and a release of radio bearers (hereinafter abbreviated RBs). The RB indicates a service provided by the 2^{nd} layer for a data delivery between the user equipment and the network. To this end, the RRC layer of the user equipment and the RRC layer of the network exchange a RRC message with each other. In case that there is an RRC connection (RRC connected) between the user equipment and the RRC layer of the network, the user equipment lies in the state of RRC connected (connected mode). Otherwise, the user equipment lies in the state of RRC idle (idle mode). A non-access stratum (NAS) layer situated at the top of the RRC layer performs such a function as a session management, a mobility management and the like.

A single cell consisting of an eNode B is set to one of 1.25 MHz, 2.5 MHz, 5 MHz, 10 MHz, 15 MHz, and 20 MHz of bandwidths and then provides a downlink or uplink transmission service to a plurality of user equipments. Different cells can be configured to provide corresponding bandwidths, respectively.

DL transport channels for transmitting data from a network to a user equipment include a BCH (broadcast channel) for transmitting a system information, a PCH (paging channel) for transmitting a paging message, a downlink SCH (shared channel) for transmitting a user traffic or a control message and the like. In this case, the downlink SCH can be classified into a DL-SCH for transmitting the user traffic and a DL L1/L2 control channel for transmitting control information on a method of processing the user traffic received on the DL-SCH and the like. The latter control information is called DL scheduling information.

The DL scheduling information may include such control informations as identifier information such as a group identifier and/or a user equipment identifier and the like, radio resource assignment information for allocating such a radio resource as time, frequency, and the like, duration of assignment information for designating a valid duration of an allocated radio resource, multi antenna information including information on multiple transmission/reception antennas (MIMO) or a beamforming scheme, modulation information, a payload size, asynchronous HARQ information, synchronous HARQ information, and the like. In this case, the asynchronous HARQ information includes a HARQ process identifier (HARQ process number), a redundancy version (RV), a new data indicator, and the like. The synchronous HARQ information includes a retransmission sequence number.

DL multicast, broadcast service traffic, or a control message may be transmitted on the DL SCH or a separate DL MCH (multicast channel).

Meanwhile, UL transport channels for transmitting data from a user equipment to a network include a RACH (random access channel) for transmitting an initial control message and an uplink SCH (shared channel) for transmitting a user traffic or a control message. In this case, the UL SCH is also classified into a UL-SCH for transmitting an actual traffic and a UL L1/L2 control channel for transmitting control information on a method of processing the traffic received on the UL-SCH and the like. The latter control information is called UL scheduling information. The UL scheduling information may include such a transmission parameter as identifier information, radio resource assignment information, duration of assignment information, multi antenna information, modulation information, a payload size, and the like.

A logical channel, which is situated above a transport channel and mapped to the transport channel, includes a BCCH (broadcast control channel), a PCCH (paging control channel), a CCCH (common control channel), a MCCH (multicast control channel), a MTCH (multicast traffic channel) and the like.

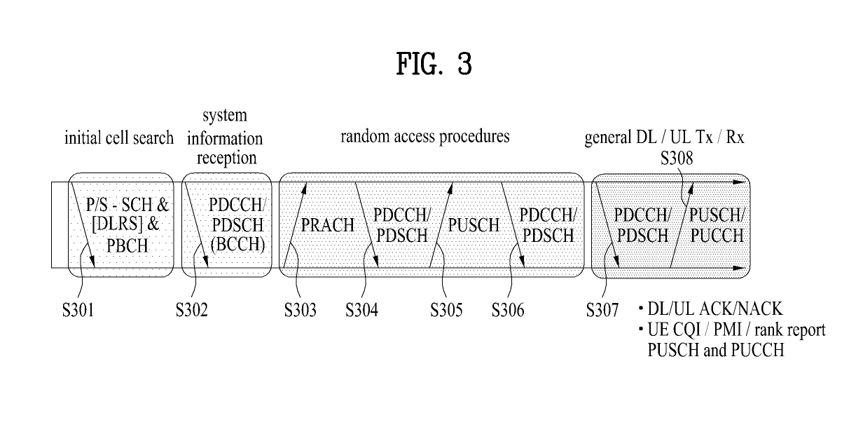

FIG. 3 is a diagram for explaining physical channels used for 3GPP system and a general signal transmission method using the physical channels.

If a power of a user equipment is turned on or the user equipment enters a new cell, the user equipment may perform an initial cell search job for matching synchronization with an eNode B and the like [S301]. To this end, the user equipment may receive a primary synchronization channel (P-SCH) and a secondary synchronization channel (S-SCH) from the eNode B, may be synchronized with the eNode B and may be then able to obtain information such as a cell ID and the like. Subsequently, the user equipment receives a physical broadcast channel from the eNode B and may be then able to obtain intra-cell broadcast information. Meanwhile, the user equipment receives a downlink reference signal (DL RS) in the initial cell search step and may be then able to check a DL channel state.

Having completed the initial cell search, the user equipment may receive a physical downlink shared control channel (PDSCH) according to a physical downlink control channel (PDCCH) and an information carried on the physical downlink control channel (PDCCH). The user equipment may be then able to obtain detailed system information [S302].

Meanwhile, if a user equipment initially accesses an eNode B or does not have a radio resource for transmitting a signal, the user equipment may be able to perform a random access procedure (RACH) to complete the access to the eNode B [S303 to S306]. To this end, the user equipment may transmit a specific sequence as a preamble on a physical random access channel (PRACH) [S303/S305] and may be then able to receive a response message on PDCCH and the corresponding PDSCH in response to the preamble [S304/S306]. In case of a contention based random access procedure (RACH), it may be able to additionally perform a contention resolution procedure.

Having performed the above mentioned procedures, the user equipment may be able to perform a PDCCH/PDSCH reception [S307] and a PUSCH/PUCCH (physical uplink shared channel/physical uplink control channel) transmission [S308] as a general uplink/downlink signal transmission procedure. In particular, the user equipment receives a DCI (downlink control information) on the PDCCH. In this case, the DCI contains such a control information as an information on resource allocation to the user equipment. The format of the DCI varies in accordance with its purpose.

Meanwhile, control information transmitted to an eNode B from a user equipment via UL or the control information received by the user equipment from the eNode B includes downlink/uplink ACK/NACK signals, CQI (Channel Quality Indicator), PMI (Precoding Matrix Index), RI (Rank Indicator) and the like. In case of 3GPP LTE system, the user equipment may be able to transmit the aforementioned control information such as CQI/PMI/RI and the like on PUSCH and/or PUCCH.

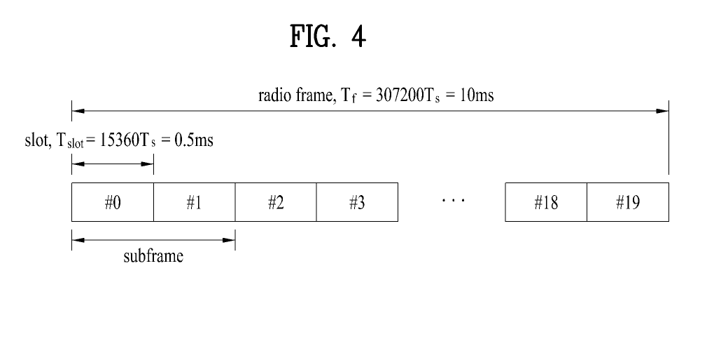

FIG. 4 is a diagram for a structure of a radio frame used in an LTE system.

Referring to FIG. 4, one radio frame has a length of 10 ms (327,200×T_{S}) and is constructed with 10 subframes in equal size. Each of the subframes has a length of 1 ms and is constructed with two slots. Each of the slots has a length of 0.5 ms (15,360×T_{S}). In this case, Tₛ indicates a sampling time and is represented as Tₛ=1/(15 kHz×2048)=3.2552×10⁻⁸ (i.e., about 33 ns). The slot includes a plurality of OFDM symbols in a time domain and also includes a plurality of resource blocks (RBs) in a frequency domain. In the LTE system, one resource block includes ‘12 subcarriers×7 or 6 OFDM symbols’. A transmission time interval (TTI), which is a unit time for transmitting data, can be determined by at least one subframe unit. The aforementioned structure of a radio frame is just exemplary. And, the number of subframes included in a radio frame, the number of slots included in a subframe and the number of OFDM symbols included in a slot may be modified in various ways.

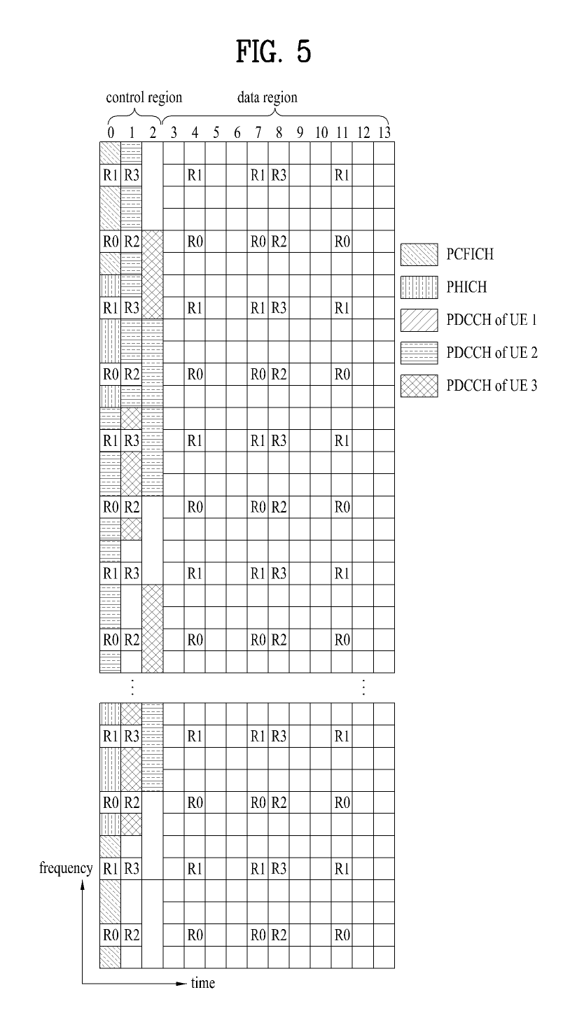

FIG. 5 is a diagram for showing an example of a control channel included in a control region of a single subframe in a DL radio frame.

Referring to FIG. 5, a subframe consists of 14 OFDM symbols. According to a subframe configuration, the first 1 to 3 OFDM symbols are used for a control region and the other 13˜11 OFDM symbols are used for a data region. In the diagram, R1 to R4 may indicate a reference signal (hereinafter abbreviated RS or a pilot signal) for an antenna 0 to 3. The RS is fixed as a constant pattern in the subframe irrespective of the control region and the data region. The control channel is allocated to a resource to which the RS is not allocated in the control region and a traffic channel is also allocated to a resource to which the RS is not allocated in the data region. The control channel allocated to the control region may include a physical control format indicator channel (PCFICH), a physical hybrid-ARQ indicator channel (PHICH), a physical downlink control channel (PDCCH) and the like.

The PCFICH is a physical control format indicator channel and informs a user equipment of the number of OFDM symbols used for the PDCCH on every subframe. The PCFICH is situated at the first OFDM symbol and is configured prior to the PHICH and the PDCCH. The PCFICH consists of 4 resource element groups (REG) and each of the REGs is distributed in the control region based on a cell ID (cell identity). One REG consists of 4 resource elements (RE). The RE may indicate a minimum physical resource defined as ‘one subcarrier×one OFDM symbol’. The value of the PCFICH may indicate the value of 1 to 3 or 2 to 4 according to a bandwidth and is modulated into a QPSK (quadrature phase shift keying).

The PHICH is a physical HARQ (hybrid-automatic repeat and request) indicator channel and used for carrying HARQ ACK/NACK for an UL transmission. In particular, the PHICH indicates a channel to which DL ACK/NACK information is transmitted for UL HARQ. The PHICH consists of a single REG and is scrambled cell-specifically. The ACK/NACK is indicated by 1 bit and modulated into BPSK (binary phase shift keying). The modulated ACK/NACK is spread into a spread factor (SF) 2 or 4. A plurality of PHICHs, which are mapped to a same resource, composes a PHICH group. The number of PHICH, which is multiplexed by the PHICH group, is determined according to the number of spreading code. The PHICH (group) is repeated three times to obtain diversity gain in a frequency domain and/or a time domain.

The PDCCH is a physical DL control channel and is allocated to the first n OFDM symbol of a subframe. In this case, the n is an integer more than 1 and indicated by the PCFICH. The PDCCH consists of at least one CCE. The PDCCH informs each of user equipments or a user equipment group of an information on a resource assignment of PCH (paging channel) and DL-SCH (downlink-shared channel), which are transmission channels, an uplink scheduling grant, HARQ information and the like. The PCH (paging channel) and the DL-SCH (downlink-shared channel) are transmitted on the PDSCH. Hence, an eNode B and the user equipment transmit and receive data via the PDSCH in general except a specific control information or a specific service data.

Information on where the data of the PDSCH is transmitted to which user equipment (one or a plurality of user equipments) and the information on how to receive and decode the PDSCH data by the user equipments and the like are transmitted in a manner of being included in the PDCCH. For instance, assume that a specific PDCCH is CRC masked with an RNTI (radio network temporary identity) called “A” and an information on data transmitted using a radio resource (e.g., frequency position) called “B” and a DCI format i.e., a transmission form information (e.g., a transmission block size, a modulation scheme, coding information, and the like) called “C” is transmitted via a specific subframe. In this case, the user equipment in a cell monitors the PDCCH using the RNTI information of its own, if there exist at least one or more user equipments having the “A” RNTI, the user equipments receive the PDCCH and the PDSCH, which is indicated by the “B” and the “C”, via the received information on the PDCCH.

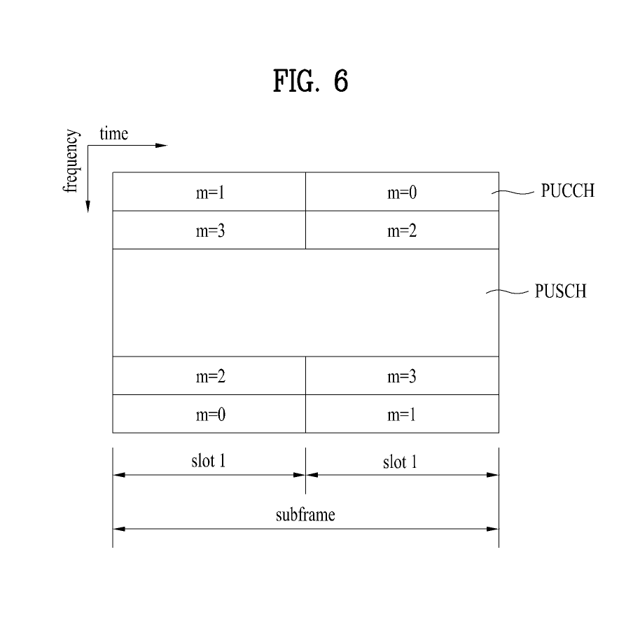

FIG. 6 is a diagram for a structure of an uplink subframe in LTE system.

Referring to FIG. 6, an UL subframe can be divided into a region to which a physical uplink control channel (PUCCH) carrying control information is assigned and a region to which a physical uplink shared channel (PUSCH) carrying a user data is assigned. A middle part of the subframe is assigned to the PUSCH and both sides of a data region are assigned to the PUCCH in a frequency domain. The control information transmitted on the PUCCH includes an ACK/NACK used for HARQ, a CQI (channel quality indicator) indicating a DL channel status, an RI (rank indicator) for MIMO, an SR (scheduling request) corresponding to an UL resource request, and the like. The PUCCH for a single UE uses one resource block, which occupies different frequencies in each slot within a subframe. In particular, 2 resource blocks assigned to the PUCCH are frequency hopped on a slot boundary. In particular, FIG. 6 shows an example that the PUCCH satisfying conditions (e.g., m=0, 1, 2, 3) is assigned to a subframe.

The present invention proposes that an eNode B manages a plurality of DL HARQ processes in a manner of making each of a plurality of the DL HARQ processes possess a transmission/reception property different from each other. In this case, the transmission/reception property includes a type of resource of which PDSCH transmission is performed, a type of subframe, an ACK/NACK transmission scheme reported as a decoding result, and the like.

According to the present invention, an eNode B can perform a PDSCH transmission optimized according to each of a plurality of HARQ processes and can perform an operation according to the optimized PDSCH transmission. In particular, the present invention may be helpful in terms of applying a scheme configured to reduce inter-cell interference in a different form on every HARQ process.

First of all, an eNode B designates a set of subframes to which a specific HARQ process corresponds via such an upper layer signal as an RRC signaling and PDSCH for the corresponding HARQ process can be configured to be transmitted in a designated subframe. In this case, the designated subframe is a number to be represented in a manner of being directly indicated by such an upper layer signal as the RRC signaling. For instance, the designated subframe can be represented by a difference (a subframe appearing after subframe k, k>0) between a subframe to which DL assignment information is transmitted and a subframe to which PDSCH is directly transmitted. Hence, a subframe can schedule PDSCH of a different subframe except the corresponding subframe without adding a separate field to PDCCH.

As an example, in a specific DL subframe set, if a stable PDCCH transmission/reception is not possible in a control region due to a significant interference from a neighbor cell, PDCCH for a corresponding DL subframe can be transmitted in a different DL subframe, which is promised by the corresponding neighbor cell not to interfere the control region. In particular, if a UE detects DL assignment information in a specific subframe #n and a corresponding HARQ process identifier is configured with a specific value, the UE interprets that corresponding PDSCH is transmitted/received in a subframe n+k (k≧1). In this case, a value of the k corresponding to a subframe difference can be determined in various forms according to the aforementioned schemes for determining a designated subframe.

### First Embodiment

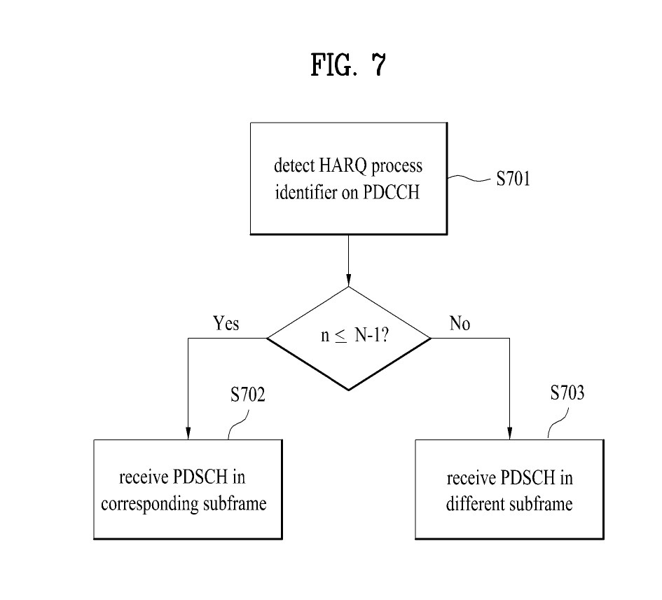

FIG. 7 is a flowchart of a method of receiving PDSCH according to a first embodiment of the present invention. In particular, assume that there are N numbers of HARQ processes in a legacy system in FIG. 7.

Referring to FIG. 7, a UE detects a HARQ process identifier in a manner of performing a blind decoding on PDCCH in the step S701.

If the HARQ process identifier included in PDCCH is set to either a conventional 0 or N-1, the UE interprets that the PDCCH schedules PDSCH reception in a corresponding subframe in the step S702. On the contrary, if the HARQ process identifier included in PDCCH is set to either N or M-1, which is not a legacy defined value, the UE interprets that the PDCCH schedules not the subframe of which received the PDCCH but a different subframe, e.g., a DL subframe appearing next or PDSCH of the subframe designated by an upper layer signal in the step S703.

In particular, if the HARQ process identifier included in PDCCH ranges from 0 to M-1, the UE divides the HARQ process identifier into two groups. And then, the UE interprets that a first group schedules reception of PDSCH in a corresponding subframe. And, the UE interprets that a second group schedules not the subframe of which received the PDCCH but a different subframe, e.g., a DL subframe appearing next or PDSCH of the subframe designated by an upper layer signal.

In this case, the M is the number of all states capable of being represented with a bit number existing in PDCCH to indicate the HARQ process identifier. If there is B bit, it becomes M=2^{B}. Or, if all of 2^{B} numbers of states are not necessary, a specific value satisfying M<2^{B} can be used to configure the M. For instance, the specific value may be configured with 15, which is a maximum value of the HARQ process shown in Table 1 or may be given by such an upper layer as an RRC.

Meanwhile, DL HARQ process number N defined by a current 3GPP LTE standard is 8 in a FDD (frequency division duplex) system and is differently defined in a TDD (time division duplex) system according to a UL/DL subframe configuration as shown in Table 1 in the following. Meanwhile, an HARQ process identifier field is represented by 3 bits in the FDD system and is represented by 4 bits in the TDD system.

TABLE 1

| UL/DL subframe configuration | Numbers of HARQ process |
|---|---|
| 0 | 4 |
| 1 | 7 |
| 2 | 10 |
| 3 | 9 |
| 4 | 12 |
| 5 | 15 |
| 6 | 6 |

According to the aforementioned description, a reserved state of the HARQ process identifier field may not be sufficient in a part of UL/DL configuration in the FDD system or the TDD system. For instance, since there exist 8 HARQ processes in case of the FDD system, there is no additional reserved state because the HARQ process identifier is indicated by 3 bits. One method of solving the aforementioned problem is to increase the number of a state of the HARQ process in a manner of assigning an additional bit to the HARQ process identifier field in PDCCH. As a different method, the state of the HARQ process is divided via such an upper layer signal as an RRC signaling and a conventional operation is performed for a part of the HARQ process identifier. Yet, the aforementioned operation, i.e., PDSCH is transmitted not in the subframe to which DL assignment information is transmitted but in a different subframe, is performed for the other HARQ process identifier.

Meanwhile, it is possible to determine an operation corresponding to an identical HARQ process identifier in relation to an index of a subframe to which DL assignment information is transmitted. For instance, in case that a HARQ process identifier of a specific reserved state is designated in the DL assignment information, if the subframe to which the corresponding DL assignment information is transmitted is a subframe designated in advance, the operation described in FIG. 7 is performed. If the subframe to which the corresponding DL assignment information is transmitted is not the subframe designated in advance, it is possible to operate to perform a legacy operation.

### Second Embodiment

A second embodiment of the present invention proposes that an eNode B transmits a DL data, i.e., PDSCH, using a UL resource (a UL frequency band in case of the FDD system, a UL subframe in case of the TDD system) in case that a DL traffic temporarily increases. Specifically, in case that the HARQ process identifier detects the DL assignment information configured with a pre-assigned value, the present invention proposes that a UE receives PDSCH in a specific UL subframe. For clarity, assume a TDD system in the following description and assume that the UL resource indicates the UL subframe.

In this case, which subframe transmits the corresponding PDSCH among the UL resource can be determined by various ways. For instance, the subframe transmitting the PDSCH may correspond to a UL subframe appearing first after the subframe to which the PDCCH is transmitted or a UL subframe designated by an RRC signaling and an upper layer signal.

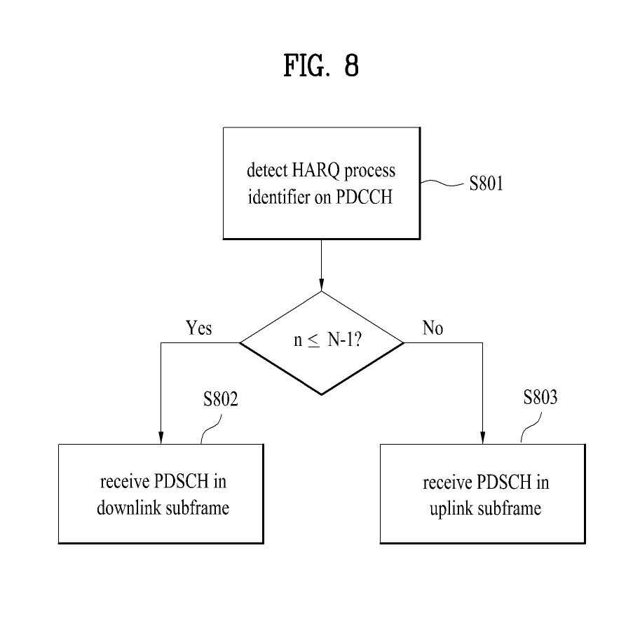

FIG. 8 is a flowchart of a method of receiving PDSCH according to a second embodiment of the present invention. In particular, assume that there are N numbers of HARQ processes in a legacy system in FIG. 8 as well. Referring to Table 1 under a situation of assuming the TDD system, N numbers of HARQ processes in the legacy system means that a UL/DL subframe configuration indicated by system information transmitted via SIB1 and the like uses N numbers of HARQ processes.

Referring to FIG. 8, a UE detects a HARQ process identifier by blind decoding PDCCH in the step S801.

If the HARQ process identifier included in PDCCH is set to either a conventional 0 or N-1, the UE interprets that the PDCCH schedules PDSCH reception in a DL subframe, in particular, in the DL subframe, which has received PDCCH in the step S802.

On the contrary, if the HARQ process identifier included in PDCCH is set to either N or M-1, which is not a legacy defined value, the UE interprets that the PDCCH schedules not the subframe, which has received the PDCCH, but a UL subframe, e.g., a UL subframe appearing first after the DL subframe to which the PDCCH is transmitted or PDSCH of the UL subframe designated by an RRC signaling and an upper layer signal in the step S803.

In this case, the M is the number of all states capable of being represented with a bit number existing in PDCCH to indicate the HARQ process identifier. If there is B bit, it becomes M=2^{B}. Or, if all of 2^{B} numbers of states are not necessary, a specific value satisfying M<2^{B} can be used to configure the M. For instance, the specific value may be configured with 15, which is a maximum value of the HARQ process shown in Table 1 or may be given by such an upper layer as an RRC. If a UL/DL subframe configuration different from the UL/DL subframe configuration indicated by the system information is signaled by an upper layer signal, the specific value can be configured with the number of HARQ process corresponding to the UL/DL subframe configuration indicated by the corresponding upper layer signal.

### Third Embodiment

According to a related art, an UL ACK/NACK for PDSCH scheduled by PDCCH is defined to be transmitted via a PUCCH resource linked to a CCE (control channel element) index of the corresponding PDCCH. Yet, according to embodiments of the present invention, since a PDCCH received subframe and a PDSCH received subframe may be different from each other, it is difficult to assign the PUCCH resource in a conventional way.

In order to solve the aforementioned problem, the third embodiment of the present invention proposes that an UL ACK/NACK resource designated in advance by such an upper layer signal as an RRC signaling is used to perform a HARQ operation for PDSCH corresponding to a specific HARQ process identifier and the HARQ operation for PDSCH corresponding to the other HARQ process uses the UL ACK/NACK resource determined according to the conventional way.

And, the present invention proposes that power control performed for the UL ACK/NACK is performed in a manner of dividing the power control according to a HARQ process identifier.

As mentioned in the foregoing description, a position of a subframe to which PDSCH is transmitted can vary according to the HARQ process identifier and the UL ACK/NACK can be transmitted by a different resource as well. In this case, it may be required a transmit power of a different level according to the resource to which the UL ACK/NACK is transmitted. In particular, in case that a neighbor cell configures an inter-cell interference mitigation scheme for a UL resource according to the UL resource, the transmit power of a different level is necessary.

Hence, the transmit power different from each other can be used for a case that PUCCH is transmitted by the UL ACK/NACK resource linked to a CCE index of PDCCH since PDSCH belongs to a normal HARQ process identifier and a case that PUCCH is semi-statically transmitted by the UL ACK/NACK resource using an RRC signaling and the like since PDSCH belongs to a specific HARQ process identifier, respectively.

For instance, a UE groups the HARQ process identifier situating on PDCCH and can configure the HARQ process identifier to operate based on a power control command transmitted from the DL assignment information belong to a same group only. In this case, HARQ process identifier group information can be transmitted by such an upper layer signal as the RRC signaling.

Or, an eNode B informs HARQ process groups different from each other of a difference value for PUCCH transmit power and the eNode B can configure an ACK/NACK for PDSCH transmitted by the specific HARQ process identifier in a manner of reflecting the difference value of the transmit power.

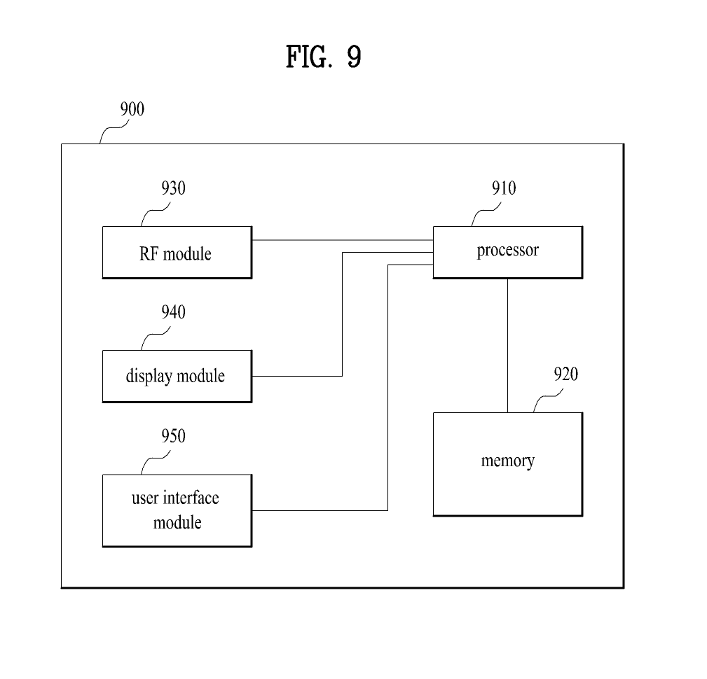

FIG. 9 is a block diagram of an example for a communication device according to one embodiment of the present invention.

Referring to FIG. 9, a communication device 900 may include a processor 910, a memory 920, an RF module 930, a display module 940, and a user interface module 950.

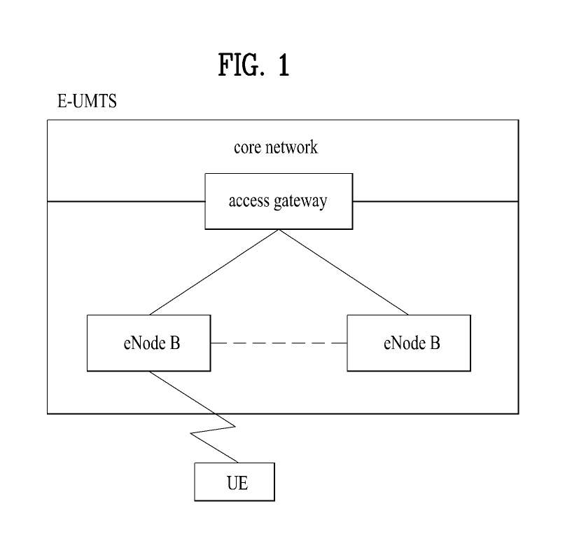

Since the communication device 900 is depicted for clarity of description, prescribed module(s) may be omitted in part. The communication device 900 may further include necessary module(s). And, a prescribed module of the communication device 900 may be divided into subdivided modules. A processor 910 is configured to perform an operation according to the embodiments of the present invention illustrated with reference to drawings. In particular, the detailed operation of the processor 910 may refer to the former contents described with reference to FIG. 1 to FIG. 8.

The memory 920 is connected with the processor 910 and stores an operating system, applications, program codes, data, and the like. The RF module 930 is connected with the processor 910 and then performs a function of converting a baseband signal to a radio signal or a function of converting a radio signal to a baseband signal. To this end, the RF module 930 performs an analog conversion, amplification, a filtering, and a frequency up conversion, or performs processes inverse to the former processes. The display module 940 is connected with the processor 910 and displays various kinds of informations. And, the display module 940 can be implemented using such a well-known component as an LCD (liquid crystal display), an LED (light emitting diode), an OLED (organic light emitting diode) display and the like, by which the present invention may be non-limited. The user interface module 950 is connected with the processor 910 and can be configured in a manner of being combined with such a well-known user interface as a keypad, a touchscreen and the like.

The above-described embodiments correspond to combinations of elements and features of the present invention in prescribed forms. And, the respective elements or features may be considered as selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Although a method of receiving a downlink signal, which is received by a user equipment from an eNode B in a wireless communication system and an apparatus therefor are described with reference to examples applied to 3GPP LTE system, it may be applicable to various kinds of wireless communication systems as well as the 3GPP LTE system.

What is claimed is:

1. A method for receiving a downlink data from an eNode B at a user equipment in a wireless communication system, the method comprising:
receiving a downlink control information from the eNode B in a first subframe;
confirming a specific identifier contained in the downlink control information; and
if the specific identifier is greater than or equal to a predetermined value, receiving the downlink data in a second subframe based on the downlink control information.

2. The method according to claim 1, if the specific identifier is less than the predetermined value, further comprising receiving the downlink data in the first subframe based on the downlink control information.

3. The method according to claim 1, wherein the specific identifier corresponds to a Hybrid Automatic Repeat and Request (HARQ) process identifier (number).

4. The method according to claim 1, wherein the second subframe corresponds to a downlink subframe defined by an upper layer signal after the first subframe.

5. The method according to claim 1, wherein the second subframe corresponds to an uplink subframe defined by an upper layer signal after the first subframe.

6. The method according to claim 2, if the downlink data is received in the first subframe, further comprising transmitting a response signal for the downlink data in a first uplink subframe linked to the downlink control information; and
if the downlink data is received in the second subframe, further comprising transmitting the response signal for the downlink data in a second uplink subframe configured by an upper layer signal.

7. The method according to claim 6, wherein the first uplink subframe and the second uplink subframe are configured with a transmit power different from each other.

8. The method according to claim 1, wherein the specific identifier greater than or equal to the predetermined value and the specific identifier less than the predetermined value correspond to a transmit power different from each other, respectively.

9. The method according to claim 1, wherein a maximum value of the specific identifier is configured by an upper layer signal.

10. A user equipment in a wireless communication system, comprising:
a radio communication module configured to transceive a signal with an eNode B; and
a processor configured to process the signal,
the radio communication module configured to receive a downlink control information from the eNode B in a first subframe, the processor configured to confirm a specific identifier contained in the downlink control information, if the specific identifier is greater than a predetermined value or equal to the predetermined value, the processor configured to control the radio communication module to receive downlink data in a second subframe based on the downlink control information.

11. The user equipment according to claim 10, wherein if the specific identifier is less than the predetermined value, the processor is configured to control the radio communication module to receive the downlink data in the first subframe based on the downlink control information.

12. The user equipment according to claim 10, wherein the specific identifier corresponds to a Hybrid Automatic Repeat and Request (HARQ) process identifier (number).

13. The user equipment according to claim 10, wherein the second subframe corresponds to a downlink subframe defined by an upper layer signal after the first subframe.

14. The user equipment according to claim 10, wherein the second subframe corresponds to an uplink subframe defined by an upper layer signal after the first subframe.

15. The user equipment according to claim 11, wherein if the downlink data is received in the first subframe, the processor is configured to control the radio communication module to transmit a response signal for the downlink data in a first uplink subframe linked to the downlink control information and wherein if the downlink data is received in the second subframe, the processor is configured to control the radio communication module to transmit the response signal for the downlink data in a second uplink subframe configured by an upper layer signal.

16. The user equipment according to claim 15, wherein the first uplink subframe and the second uplink subframe are configured with a transmit power different from each other.

17. The user equipment according to claim 10, wherein the specific identifier greater than or equal to the predetermined value and the specific identifier less than the predetermined value correspond to a transmit power different from each other, respectively.

18. The user equipment according to claim 10, wherein a maximum value of the specific identifier is configured by an upper layer signal.
